(19) United States
(12) Patent Application Publication
(10) Pub. No.: US 2017/0370116 A1
(43) Pub. Date: Dec. 28, 2017

(54) PORTABLE ADAPTIVE UNIBODY BUILDING

(71) Applicant: Joseph Cincotta, Wilmington, VT (US)

(72) Inventor: Joseph Cincotta, Wilmington, VT (US)

(73) Assignee: Wheel Pad L3C, Wilmington, VT (US)

(21) Appl. No.: 15/633,717

(22) Filed: Jun. 26, 2017

Related U.S. Application Data
(60) Provisional application No. 62/354,751, filed on Jun. 25, 2016.

(51) Int. Cl. E04H 1/02; B60P 3/32; E04B 1/343; E04H 1/12

(52) U.S. Cl. CPC E04H 1/02; E04B 1/34336; B60P 3/32; E04H 1/12

(57) ABSTRACT

A portable unibody living facility is provided that includes a living unit attached to a trailer. The living unit may be connected to a host house via a connector through which electrical and plumbing connections may be made. The living unit is accessible and includes an accessible shower area, a bedroom area, and a hoist track system integrated into the ceiling and running from the bedroom area to the shower area.

### RELATED APPLICATION DATA

This application claims the benefit of Provisional Application for Patent Ser. No. 62/354,751 filed on Jun. 25, 2016.

### FIELD OF THE INVENTION

The present invention generally relates to the field of portable healthcare buildings. In particular, the present invention is directed to a portable adaptive unibody building.

### BACKGROUND

Individuals affected by debilitating injury or illness often require extra care and/or modified living accommodations. Staying in hospitals or other health care facilities long term may be undesirable, inconvenient, and/or expensive. Additionally, remodeling a patient's home or the home of a relative/caregiver may be too expensive, take too long, or otherwise be an undesirable option.

A temporary living facility that can be removably attached to an existing home can provide a better option in many cases.

### SUMMARY OF THE DISCLOSURE

It is an object of the present invention to provide a portable, accessible living facility that includes a trailer having a chassis, a housing compartment attached to the chassis and including a door, a bedroom area, a bathroom area, and a hoist track running between the bathroom area and the bedroom area, and a connector having a first end and a second end, the connector configured to be removably attached to the housing compartment on the first end and to an existing building on the second end. The connector includes a coil assembly including single ply membrane roofing material over an adjustable coil, a first door panel on the first end configured to be secured over the door, a second door panel on the second end configured to be secured over an opening in an existing building, a floor, a roof frame, and welded wire fabric configured to be wrapped around the coil to hold the coil in a position.

It is another object of the present invention to provide a portable living facility having a trailer with a chassis, a housing compartment with a front side and a rear side, the housing compartment including wall plates bolted directly to the chassis, a plurality of structurally insulated wall panels, and a single continuous roof panel, wherein the structurally insulated wall panels have an inside side and an outside side and the structurally insulated wall panels overlap the wall plates on both the inside side and the outside side where the structurally insulated panels are attached to the wall plates wherein the roof panel is attached to the structurally insulated wall panels, and wherein the housing compartment includes a plurality of windows. In addition, the living facility includes a bedroom area in the housing compartment, a bathroom area in the housing compartment, a hoist track attached to the roof panel without additional structural bracing, the hoist track extending from the bedroom area to the bathroom area, a first door on the front side leading to an accessible ramp outside the housing compartment, and a second door on the rear side leading into a connector that is designed and configured to be removably attached on a first end to an outside of the rear side of the housing compartment and designed and configured to be removably attached on a second end to an opening of an existing building, wherein the connector is designed and configured to form a weather-tight connection between the housing compartment and an existing structure and wherein the connector is designed and configured to contain equipment for conveying electrical and plumbing services from an existing structure to the housing compartment.

It is another object of the invention to provide a living facility that has a trailer having a chassis that includes a steel perimeter frame with a monolithic structural insulated panel attached, a housing compartment attached to the trailer, the housing compartment including wall plates bolted directly to the chassis, a plurality of structurally insulated wall panels, and a single continuous roof panel, wherein the structurally insulated wall panels have an inside side and an outside side and the structurally insulated wall panels overlap the wall plates on both the inside side and the outside side where the structurally insulated panels are attached to the wall plates and wherein the roof panel is attached to the structurally insulated wall panels, a bedroom area and a bathroom area. The housing compartment also includes a hoist track supported by the roof panel, the hoist track extending from the bedroom area to the bathroom area, a door leading from inside the housing compartment to outside the housing compartment, and a connector designed and configured to be removably attached on a first end to an outside of the housing compartment and to surround the door and designed and configured to be removably attached on a second end to an existing building such that direct access between the existing building and the housing compartment is allowed, wherein the connector is designed and configured to form a weather-tight connection between the housing compartment and an existing structure and wherein the connector is designed and configured to contain equipment for conveying electrical and plumbing services from an existing structure to the housing compartment.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary perspective, partially exploded view of an aspect of an embodiment of the invention;

FIG. 2A depicts an alternative trailer in accordance with an embodiment of the present invention;

FIG. 2B is a partial view of the trailer of FIG. 2A;

FIG. 3 is an exploded view of an exemplary living facility in accordance with aspects of the invention;

FIG. 4 is an exploded view of vented siding in accordance with aspects of an embodiment of the invention;

FIG. 5 is a plan view of an exemplary living facility in accordance with aspects of the invention;

FIG. 6 is an exemplary perspective view of a cavity chase wall with cantilevered sink in accordance with aspects of the invention;

FIG. 7A depicts an aspect of the present invention;

FIG. 7B is a side view of the aspect shown in FIG. 7A; and

FIG. 8 is an exemplary perspective view of insulated exterior window and door shutters in in accordance with aspects of the invention.

### DESCRIPTION OF THE DISCLOSURE

A living facility suitable for individuals requiring care and/or having mobility issues is provided that is portable and can be removably connected to an existing structure, such as a residence, to allow direct access to the existing structure while remaining on a trailer. The living facility may serve as an alternative to making construction modifications to a residence to accommodate another individual, especially one requiring care and/or having mobility issues since many existing residences are not designed to accommodate those requiring care and/or having mobility issues.

The living facility can be made directly accessible through a connection to the existing structure thereby allowing occupants of the existing structure, or host house, to easily and conveniently get to the living facility while affording the patient a sense of privacy and independence. The living facility also allows the occupants of the host house to minimize any disruption and inconvenience associated with adapting the home to meet the needs of the patient and having a patient in the home while maintaining the peace of mind that having the patient on premises provides.

The living facility may include electrical connections to the existing structure as well as a plumbing system. Additional features may include an integral hoist track, unibody construction, portable ramp and decking, and a weather-tight, adjustable connector between the living facility and the host house.

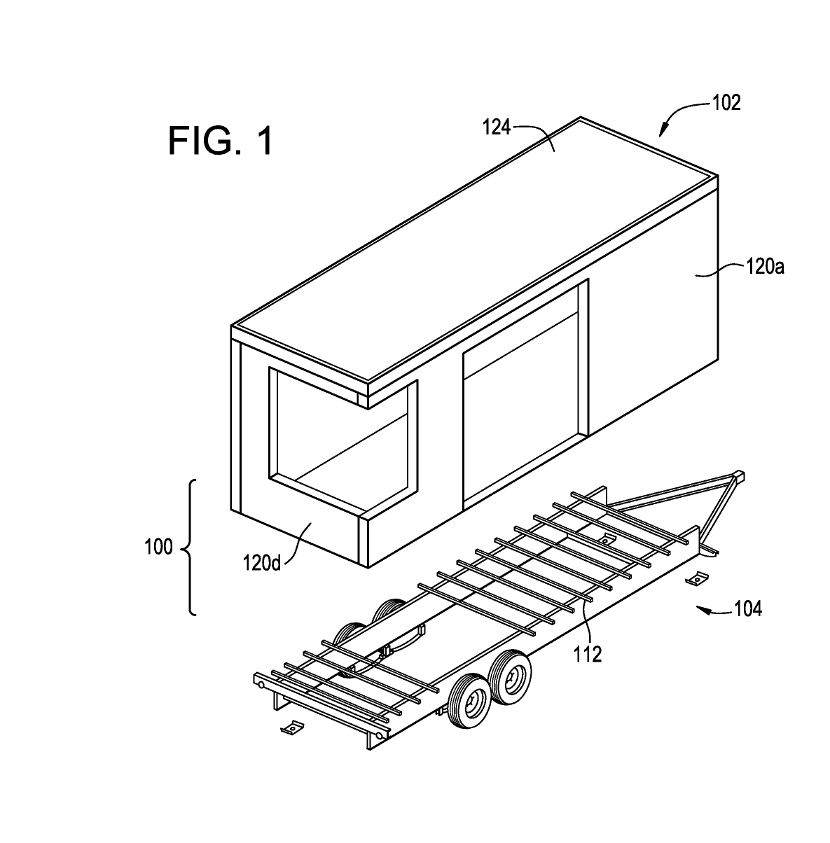

FIG. 1 depicts a portable living facility 100 of the present invention, which includes a living unit 102 that is supported on and can be transported when necessary on a trailer 104. Living facility 100 is sized and configured to be transported on roadways. Trailer 104 may have a steel chassis 112.

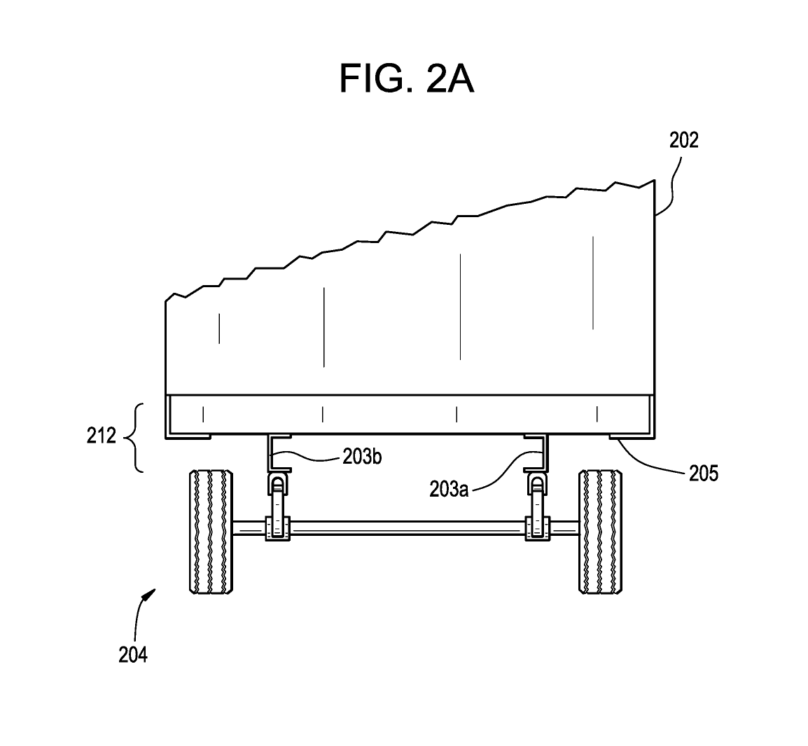

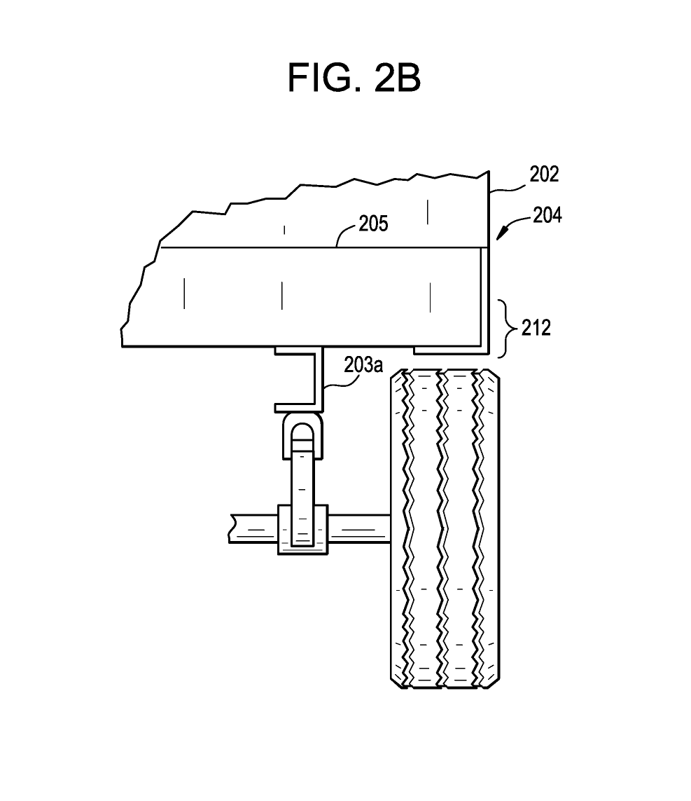

Alternatively, as shown in FIGS. 2A-2B, another trailer, trailer 204, may have a steel perimeter frame 203 (e.g., 203a, 203b) with a monolithic structural insulated panel 205 (structural insulated panels are discussed further below) attached to form a unique hybrid trailer chassis 212 to which a living unit, unit 202 (same as unit 102), is secured. The design of trailer 204 is lighter while also greatly increasing insulating value and strength.

In addition, trailer 104 may include suspension wheel and axle assembly components that are removable to facilitate the insertion of skids. Skids permit living facility 100 to be installed at various heights in order to allow unit 102 to be aligned with a host house. The wheel assembly as well as stabilization jacks of trailer 104 are continuously welded to the chassis. Optionally, trailer 104 may include a removable trailer hitch tongue that can be secured to either side of trailer 104 to facilitate easier installation near the host house.

Unit 102 may be constructed to be practically squeak free by using a unibody construction that allows the chassis, floor, walls, and roof to effectively act as one piece. The integral bond between these elements is achieved with a redundant application of mechanical fasteners and a continuous application of structural adhesives. In particular, with reference now to FIGS. 1-3, floor 108 of living facility 100 is continuously secured to welded chassis 112 of trailer 104 with heavy duty steel bolts and wooden plates that are bonded to the steel with a structural adhesive. Wall plates 116 are secured directly to chassis 112 with a continuous application of structural adhesive along with integrally welded bolts that fasten wall plates 116 directly to chassis 112. These integrally welded bolts thus function to secure unit 102 to trailer 104 in manner similar to how a stationary house is typically secured to its concrete foundation.

Wall plates 116 are secured to wall panels 120 (e.g., 120a-120d), which may preferably be structurally insulated panels, with structural adhesive and continuous panel overlap on both the interior and exterior faces of the wall, which is twice the overlap found in typical construction of manufactured housing where panel overlap only occurs on the outside of the plate. This Structural Insulated Panel construction is also known as a “SIP” construction and structurally insulated panels in accordance with such construction may be manufactured as an engineered assembly of insulating foam with two panels of Oriented Strand Board (OSB), structurally laminated to both broad surfaces. SIP panels can be obtained from a number of vendors such as, Foard Panel, Inc. of Chesterfield, N.H. The continuous panel overlap on both the interior and exterior allows wall panels 120 to be secured continuously to wall plates 116 on both sides of wall panels 120. Wall panels 120 are also mechanically fastened one to the other and adhered with joint cavities that are foamed in place with a high strength insulating adhesive foam.

The unitized wall panel 120 and floor 108 assembly is further solidified by attaching a single continuous roof panel 124 to the tops of wall panels 120. This provides a rigid structural diaphragm at both the top and bottom of unit 102. This utilization of a continuous structural skin on the interior and exterior strengthens the unibody construction. All construction corners and seams are secured with separate interior and exterior mending plates that eliminate thermal bridging.

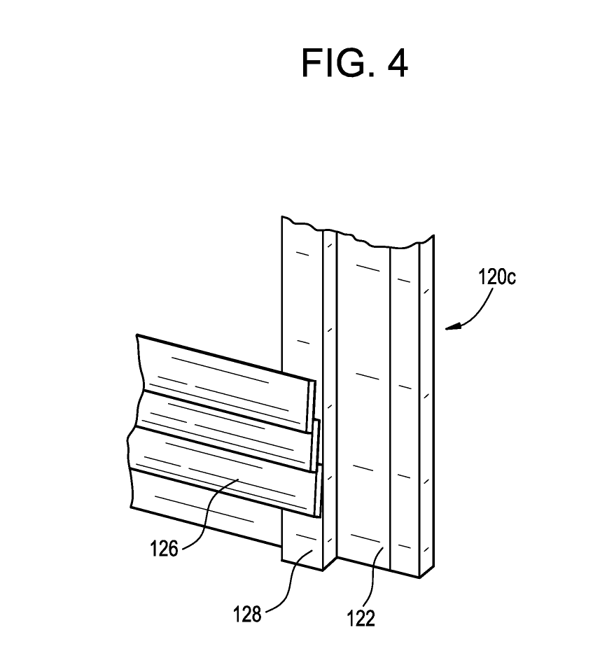

A back vented siding may be applied to continuous wood members that surround all sides of unit 102. As shown in FIG. 4, unit 102 may be covered with a vented siding, which may also be referred to as a “Rain Screen.” Vent strapping 128 is attached to wall panels 120 over any sheathing 122 and may be typically 1×3 boards. Siding 126 is attached to vent strapping 128. Each strapping 128 is secured from top to bottom and thus serves as a continuous structural strap similar to continuous earthquake ties that may be used in frame construction. These many integral straps of solid wood offer another level of redundancy in tying the entire structure of living facility 100 together and air vent space formed has the further advantage of adding to the insulation value of the wall assembly.

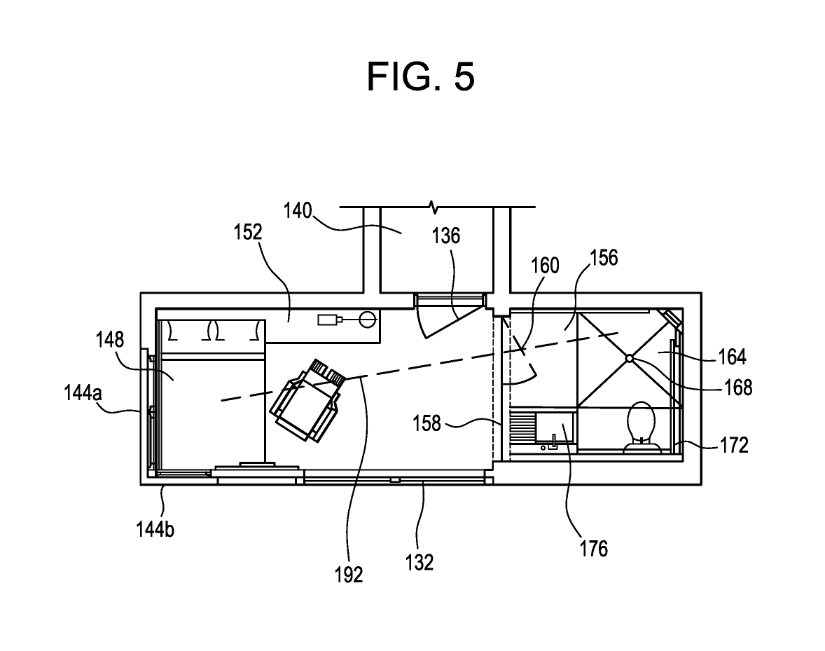

Turning to FIG. 5, the floor plan of unit 102 is designed to comfortably accommodate a patient and be functionally accessible. The floor plan of unit 102 includes a first exterior door 132 that leads to optional deck 130 and/or ramp 134 (not shown in FIG. 5). A second door 136 leads to a second exit or to the interior of a host house through a connector 140 (discussed in more detail below). Various windows 144 (e.g., 144a, 144b) provide ample natural light. A first area 148 serves as a bedroom and may include a foldable shelf 152 that can be reached by a patient from a bed and can be folded out of the way to facilitate egress on and off of a bed.

A second area 156 serves as a bath area and may include privacy glass panels 158 to separate the bath area from the bedroom, although it will be understood that other materials may be used to provide this separation. Glass panels 158 may be frosted from the floor up to the top of an interior door 160, which may preferably be a standard height of eighty inches or run from floor to ceiling to accommodate a hoist track (discussed below). Above standard door height, the glass may be transparent to visually extend the ceiling lines from both areas and maximize the apparent size of each area.

The bath area includes a roll in shower area 164 that uses an integral floor drain 168. The drainage area may be created with a shower drain pan that tapers on four sides. A continuous non-slip floor finish covers the entire shower area 164 and slopes down seamlessly to drain 168. The same flooring flashes up the walls surrounding shower area 164 with a gentle 1.5″ radius curve 170 known as a “cove stick.” The bath area may also include amenities such as a glass grab rail 172 to enhance the interior environment to provide a welcome distinction to the institutional look and feel of hospitals and rehabilitation centers. It will be understood that any suitable grab rail may used, including clear acrylic, for example. Glass grab rail 172 may use laboratory glass billet rods held in place with finished metal hardware and can be finished with custom polished ends and miters where they meet at the corners. In addition, a glass and zinc basin 176 may enhance the interior environment to provide a welcome distinction to the institutional look and feel of hospitals and rehabilitation centers. It will be understood that other materials may be used for basin 176, such as porcelain.

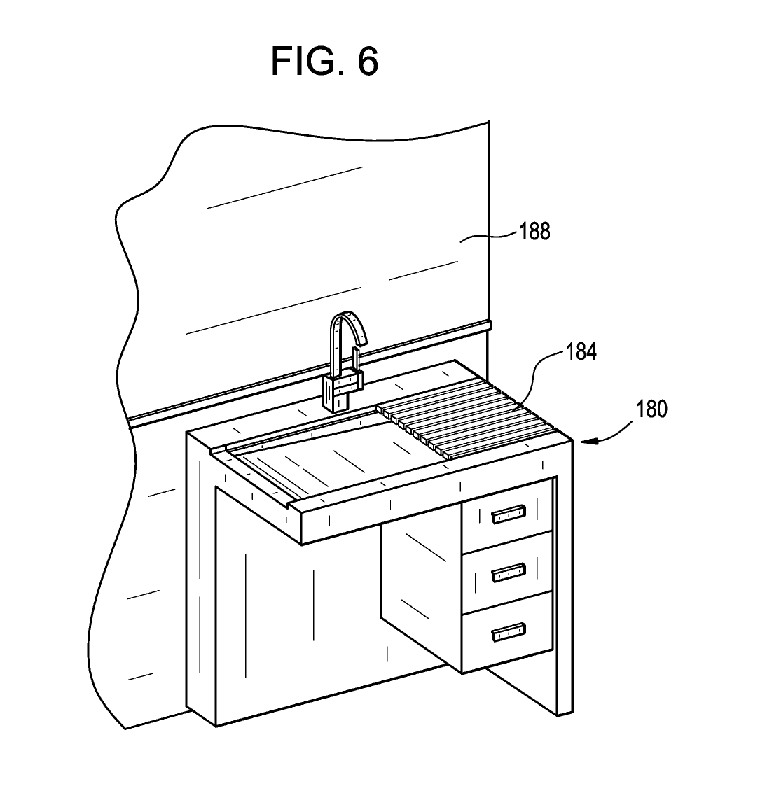

A sink 180 is designed and attached to the plumbing wall such that sink 180 cantilevers over the floor and thus provides wheelchair access from the two open sides, as can be seen in FIG. 6.

Sink 180 drains into a stainless steel drain trap that may be concealed under a grate 184, which may be made of teak wood or other suitable material. A chase wall 188 to which sink 180 is attached conceals the mechanical, electrical, and plumbing lines while at the same time facilitating via removable panels easy access to the plumbing, as well as a bath fan.

An integral hoist track system may be included within unit 102 to assist with the mobility of the patient. With the above described unibody construction of unit 102, supplemental bracing may not be necessary to support the hoist track system. This allows for an economical alternative to costly track systems that require special structural bracing before they are installed. The purpose of the hoist track system is to assist in the conveyance of an occupant from the bed to the shower, for example. It is noted that the hoist system may be used by a patient to transport them to any area of a wheel pad. The hoist track system, an exemplary path 192 for which is outlined in FIG. 5, includes a hoist plate, such as a wooden structural plate, that is secured to roof panel 124 and insulated ceiling using repetitive fasteners similar to a piano hinge along with a structural adhesive. In this way, the hoist track plate can be concealed flush with the ceiling finish. An optional rope and pulley system enables self-powered transit along the hoist track. A full height shower type door would permit the hoist track to move continuously from the sleeping area to the bathroom. A noise dampening wheel assembly helps minimize the sound made when the hoist track is used.

When portable living facility 100 can be placed near a host house, connector 140 may allow direct access between living facility 100 and the host house. Connector 140 is weather-tight and insulated and, in additional to allowing people to go directly between the host house and living facility 100, can carry the mechanical, electrical, and plumbing services to/from the host house to/from the living facility.

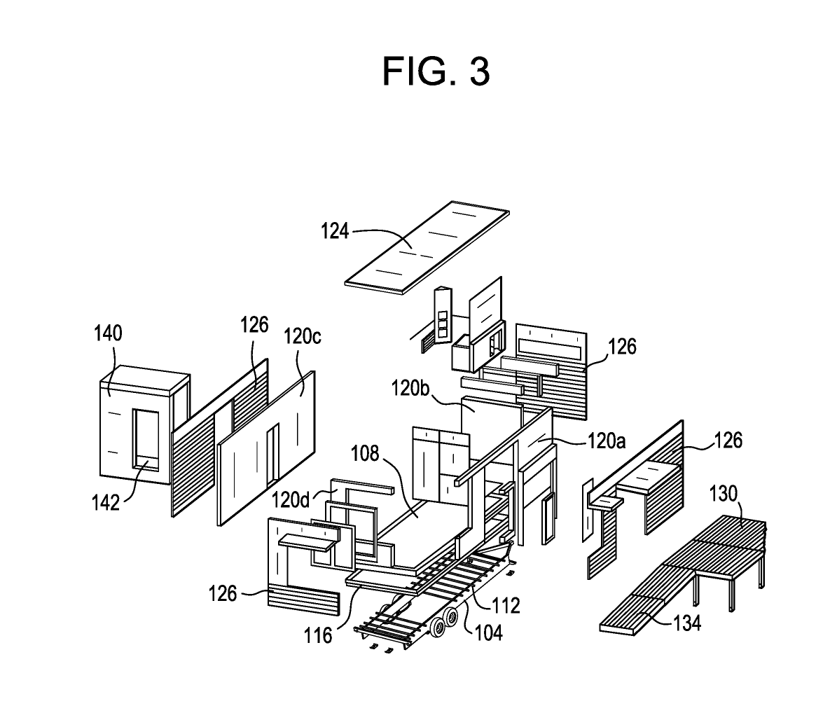

When living facility 100 is connected to a host house, connector 140 may include an exterior door 142 (shown in FIG. 3) to facilitate direct access to the host house from the exterior to alleviate the need to use another egress to enter the host house or to have to go through living facility 100 to enter the host house.

When a door of the host house is not available or practical, a window opening may be modified such that a portion of the wall below the window sill is removed temporarily to create direct access through connector 140 while living facility 100 is in place.

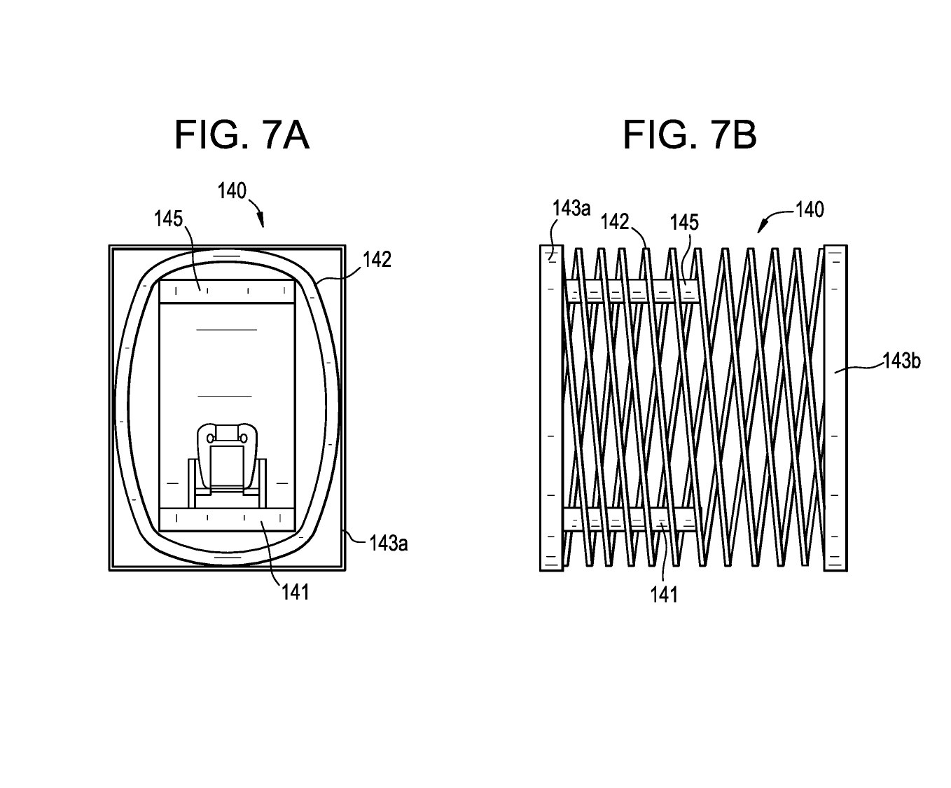

As shown in FIGS. 7A-7B, connector 140 includes a coil assembly 142 made with single ply membrane roofing over an adjustable coil and secured on both ends to portals 143. A first portal 143a is secured to the host house and a second portal 143b is secured to unit 102 around second door 136. The adjustability of coil assembly 142 permits connector 140 to connect unit 102 to an opening in a host house under a variety of circumstances. For example, there may be obstacles or other reasons that living facility 100 cannot be placed directly in front of an opening of a host house and/or be placed very close to the host house. Once connector 140 is in place, the coil of adjustable coil assembly 142 is tied off with a full wrap of welded wire fabric to secure the final spacing and structure. The interior space of connector 140 may be finished with fire treated thin plywood veneer panels.

A floor 141 and roof frame 145 of connector 140 can be cut to length once the spacing between the host house and living facility 100 is determined and be made of one piece structural insulated panels. These panels are then secured to coil assembly 142. The exterior of coil assembly 142 is wrapped in a blanket of fireproof mineral wool insulation and finished with fire treated thin plywood veneer panels and weatherized with an elastomeric paint or a fully adhered single ply roofing membrane.

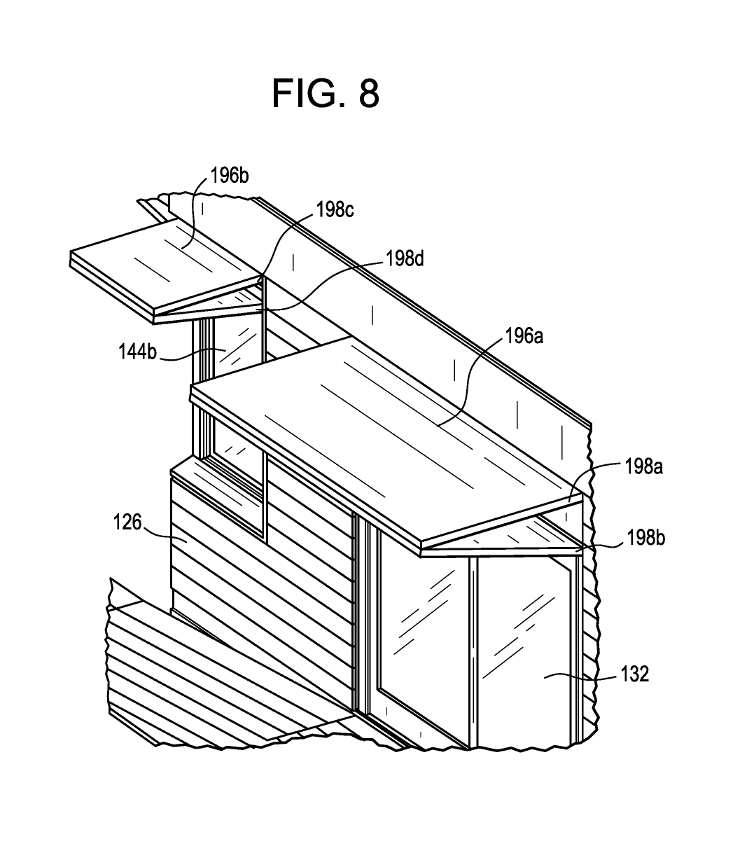

Unit 102 is energy efficient due to the continuous insulation available through the use of Structural Insulated Panel construction, as well as preferably in some embodiments through the use of insulation in the floor and ceiling. To increase the insulation at the door and window areas, unit 102 may include full coverage insulated shutters 196 (e.g., 196a, 196b) made with insulating foam covered with fully adhered metal flashing, as shown in FIG. 8. In the closed position, panels 198 (e.g., 198a-198d) of shutters 196 significantly reduce heat loss and maintain a dark interior. The recessed side walls accept panels 198 so that they close flush with the exterior wall face, which affords the advantage of lapping the recessed wall to maximize energy efficiency and seal out daylight. Patients in convalescence benefit from the option of closing off natural daylight to enhance the opportunity for sleeping hours when necessary. Panels 198 may be hinged horizontally in order to fold in half (as shown in FIG. 8) so as to act as canopies or sunshades when in the open position.

Other features of living facility 100 may include the use of corrugated metal as a special lightweight finish in the bathroom and to hide the hot water heater. Fasteners securing these finishes are easily released to provide easy access to the plumbing walls. Latex reinforced tile adhesive may be used as a lightweight wall finish applied as a finish stucco directly over the wall sheathing. Fire treated wood finish thin veneer plywood may be used as a wainscoting. In addition, fire treated rough sawn wood ceiling panels may be used to conceal wiring and provide a unique natural material finish.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A portable, accessible living facility comprising:
a trailer having a chassis that includes a steel perimeter frame with a monolithic structural insulated panel attached;
a housing compartment attached to the trailer, the housing compartment including wall plates bolted directly to the chassis, a plurality of structurally insulated wall panels, and a single continuous roof panel, wherein the structurally insulated wall panels have an inside side and an outside side and the structurally insulated wall panels overlap the wall plates on both the inside side and the outside side where the structurally insulated panels are attached to the wall plates and wherein the roof panel is attached to the structurally insulated wall panels;
a bedroom area in the housing compartment;
a bathroom area in the housing compartment;
a hoist track supported by the roof panel, the hoist track extending from the bedroom area to the bathroom area;
a door leading from inside the housing compartment to outside the housing compartment; and
a connector designed and configured to be removably attached on a first end to an outside of the housing compartment and to surround the door and designed and configured to be removably attached on a second end to an existing building such that direct access between the existing building and the housing compartment is allowed, wherein the connector is designed and configured to form a weather-tight connection between the housing compartment and an existing structure and wherein the connector is designed and configured to contain equipment for conveying electrical and plumbing services from an existing structure to the housing compartment.

2. The living facility of claim 1 wherein the connector includes an exterior door.

3. The living facility of claim 1 further including horizontally hinged insulated shutters.

4. The living facility of claim 1 further including a cantilevered sink in the bathroom area that is open on two adjacent sides to allow wheelchair access.

5. The living facility of claim 1 further including a frosted glass wall between the bathroom area and the bedroom area.

6. The living facility of claim 1 further including vented siding on the outside of the housing compartment, a clear safety grab rail in the bathroom area, and an integral shower floor drain.

7. The living facility of claim 1 wherein the housing compartment includes a second door leading to outside the housing compartment that is opposite the door, wherein a deck is attached to the outside of the housing compartment proximate the second door, and wherein an accessible ramp is attached to the deck.

8. The living facility of claim 7 wherein the deck and the ramp are removable and re-attachable.

9. The living facility of claim 1 wherein the hoist track includes a rope and pulley system configured to enable self-powered transit along the hoist track.

10. A portable, accessible living facility comprising:
a trailer including a chassis;
a housing compartment with a front side and a rear side, the housing compartment including wall plates bolted directly to the chassis, a plurality of structurally insulated wall panels, and a single continuous roof panel, wherein the structurally insulated wall panels have an inside side and an outside side and the structurally insulated wall panels overlap the wall plates on both the inside side and the outside side where the structurally insulated panels are attached to the wall plates wherein the roof panel is attached to the structurally insulated wall panels, and wherein the housing compartment includes a plurality of windows;
a bedroom area in the housing compartment;
a bathroom area in the housing compartment;
a hoist track attached to the roof panel without additional structural bracing, the hoist track extending from the bedroom area to the bathroom area;
a first door on the front side leading to an accessible ramp outside the housing compartment; and
a second door on the rear side leading into a connector that is designed and configured to be removably attached on a first end to an outside of the rear side of the housing compartment and designed and configured to be removably attached on a second end to an opening of an existing building, wherein the connector is designed and configured to form a weather-tight connection between the housing compartment and an existing structure and wherein the connector is designed and configured to contain equipment for conveying electrical and plumbing services from an existing structure to the housing compartment.

11. The living facility of claim 10 wherein the connector includes a door that allows direct access to the outside.

12. The living facility of claim 10 further including a plurality of horizontally hinged insulated shutters sized and configured to reversibly cover the plurality of windows and the first door.

13. The living facility of claim 10 further including a cantilevered sink in the bathroom area that is open on two adjacent sides to allow wheelchair access.

14. The living facility of claim 10 further including a frosted glass wall between the bathroom area and the bedroom area.

15. The living facility of claim 10 further including vented siding on the outside of the housing compartment, a clear safety grab rail in the bathroom area, and an integral shower floor drain.

16. The living facility of claim 10 wherein the hoist track includes a rope and pulley system configured to enable self-powered transit along the hoist track.

17. The living facility of claim 10 further including a floor to ceiling interior door leading to the bathroom area and over which the hoist track passes.

18. A portable, accessible living facility comprising:
a trailer including a chassis;
a housing compartment attached to the chassis and including a door, a bedroom area, a bathroom area, and a hoist track running between the bathroom area and the bedroom area; and
a connector having a first end and a second end, the connector configured to be removably attached to the housing compartment on the first end and to an existing building on the second end, wherein the connector includes:
a coil assembly including single ply membrane roofing material over an adjustable coil, a first door panel on the first end configured to be secured over the door;
a second door panel on the second end configured to be secured over an opening in an existing building,
a floor,
a roof frame, and
welded wire fabric configured to be wrapped around the coil to hold the coil in a position.

19. The portable, accessible living facility of claim 18 wherein the housing compartment includes wall plates bolted to the chassis, a plurality of structurally insulated wall panels, and a single continuous roof panel, wherein the structurally insulated wall panels have an inside side and an outside side and the structurally insulated wall panels overlap the wall plates on both the inside side and the outside side where the structurally insulated panels are attached to the wall plates and wherein the roof panel is attached to the structurally insulated wall panels.

20. The portable accessible living facility of claim 19 wherein the chassis includes a steel perimeter frame with a monolithic structural insulated panel attached.
